(19) United States
(12) Patent Application Publication
(10) Pub. No.: US 2014/0299205 A1
(43) Pub. Date: Oct. 9, 2014

(54) COIL SPRING/RELIEF VALVE ASSEMBLY FOR AN OIL FILTER

(71) Applicant: West Troy, LLC, Troy, OH (US)

(72) Inventor: Sean M. Boston, Arcanum, OH (US)

(73) Assignee: WEST TROY, LLC, Troy, OH (US)

(21) Appl. No.: 14/209,112

(22) Filed: Mar. 13, 2014

Related U.S. Application Data
(60) Provisional application No. 61/802,553, filed on Mar. 16, 2013.

(51) Int. Cl. F16K 17/04

(52) U.S. Cl. CPC F16K 17/04
USPC 137/535

(57) ABSTRACT

A coil spring/relief valve and an oil filter assembly comprising an oil filter housing, filter media, and the coil spring/relief valve are provided. The coil spring/relief valve may comprise a valve assembly comprising a valve can, a sealing member, a relief spring, a coil spring that may be used to keep constant pressure against the filter media, and a pressure relief valve can. The sealing member and the relief spring can be mounted on the pressure relief valve can. The coil spring and the pressure relief valve can may be held together as a one piece assembly within the oil filter housing. The valve can receives the coil spring, which can be supported by the oil filter housing, to force the valve can into contact with the oil filter media with a constant pressure.

### CROSS-REFERENCE TO RELATED APPLICATIONS

This application claims the benefit of U.S. Provisional Application Ser. No. 61/802,553, filed Mar. 16, 2013.

### FIELD OF THE INVENTION

The present invention relates to oil filter assemblies and in particular to relief valves of the type used in oil filters.

### BACKGROUND OF THE INVENTION

It is well known in the art that some oil filters do not apply constant pressure to the filter media. Also, in filters that use coil springs to secure the filter media to its housing, the springs are not attached to anything and could cause a problem during filter assembly. Some filters, that do not use coil spring, do not apply constant pressure to the filter media and allow leaking.

The present invention offers a suitable solution to both problems, a spring attached to the pressure relief valve does not fall over during assembly. Also, if the non-coil spring filters use coil springs the filters have no chance of leaking.

### SUMMARY OF THE INVENTION

According to one embodiment, a coil spring/relief valve assembly for oil filters is provided. The assembly comprises a valve assembly comprising a sealing member and a spring, a coil spring to keep constant pressure against filter media, and a pressure relief valve can, wherein the pressure relief valve can and the coil spring are clenched to hold spring in place.

In other embodiments, a coil spring/relief valve and an oil filter assembly comprising an oil filter housing, filter media, and the coil spring/relief valve are provided. The coil spring/relief valve may comprise a valve assembly comprising a valve can, a sealing member, a relief spring, a coil spring that may be used to keep constant pressure against the filter media, and a pressure relief valve can. The sealing member and the relief spring can be mounted on the pressure relief valve can. The coil spring and the pressure relief valve can may be held together as a one piece assembly within the oil filter housing. The valve can receives the coil spring, which can be supported by the oil filter housing, to force the valve can into contact with the oil filter media with a constant pressure.

### BRIEF DESCRIPTION OF THE DRAWINGS

FIG. 1 shows a side view of the relief valve and spring assembly of the present invention;

FIG. 2 is a plan view of the valve taken from the spring side of the assembly;

FIG. 3 is a sectional view taken along lines A-A in FIG. 2 and showing the assembly between the valve can and the spring; and

FIG. 4 is a perspective view of the relief valve of the present invention.

### DETAILED DESCRIPTION OF THE INVENTION

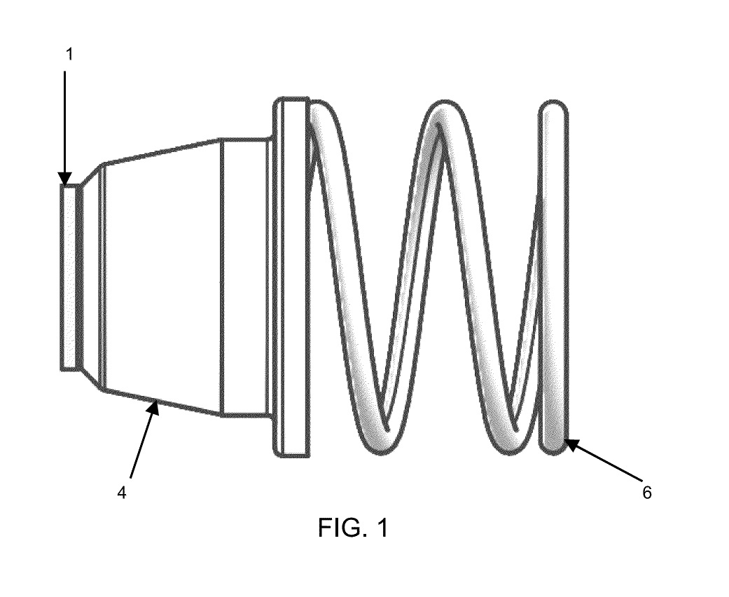

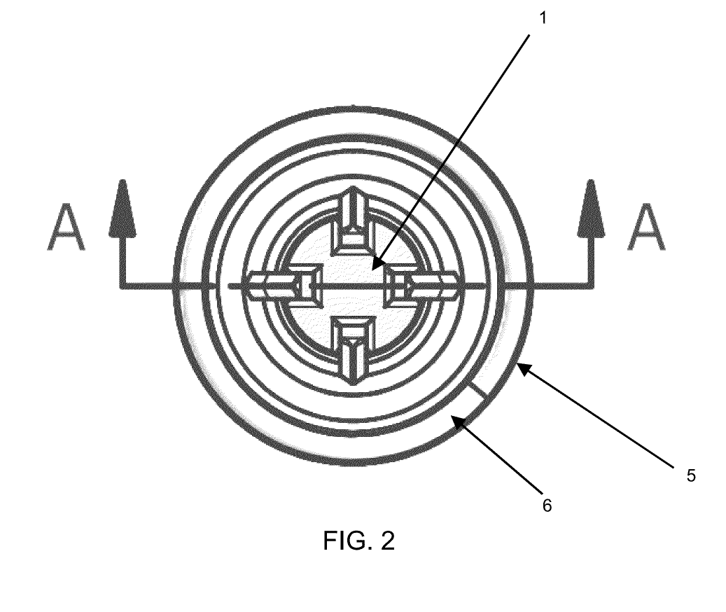

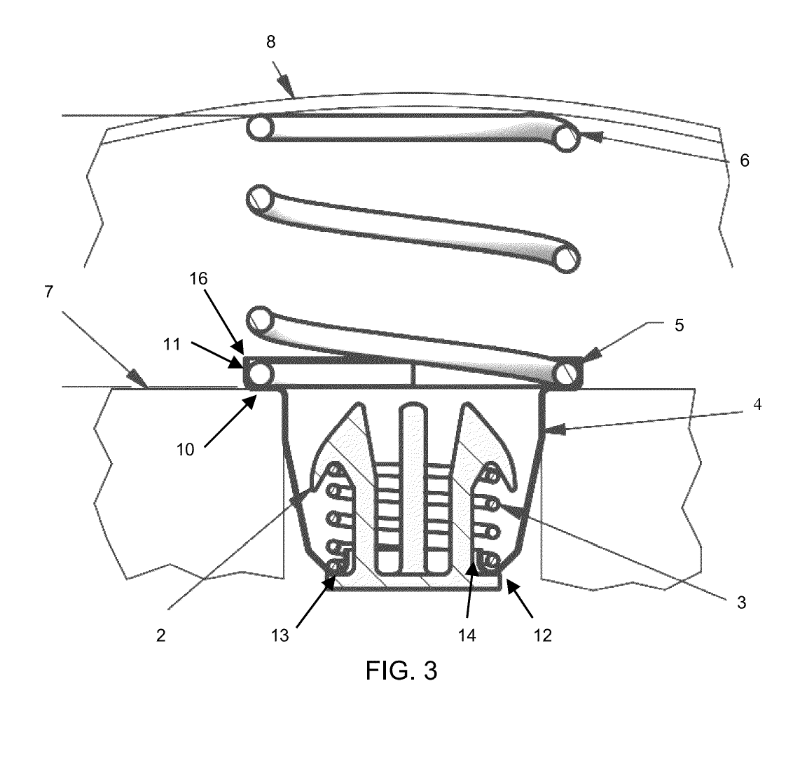

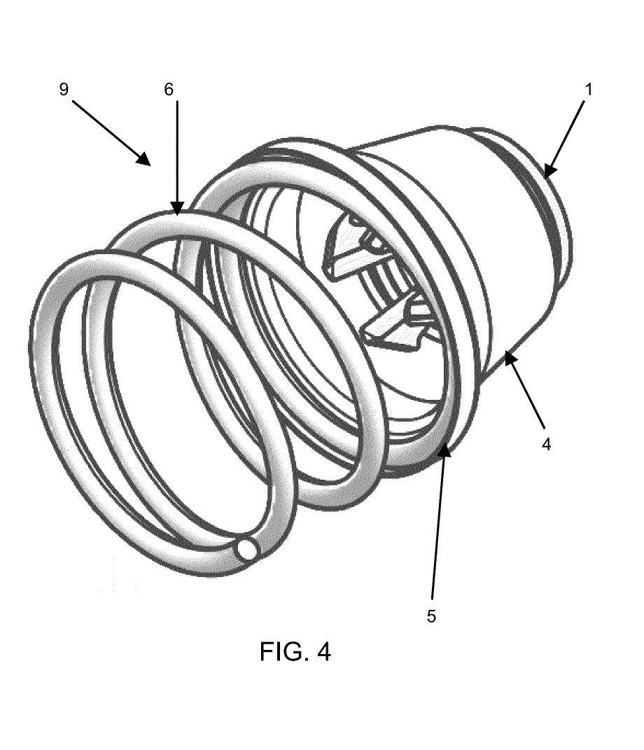

The present invention relates to a relief valve and coil spring assembly as shown in FIGS. 1-4, in which a relief valve 1, of a type used by oil filter manufacturers is shown, the valve includes a sealing member 2 and a relief spring 3 and is operatively mounted on a valve can 4, to form a complete valve assembly.

As known in the art, the oil filter relief valves are generally mounted between an unfiltered oil zone and a clean oil zone and the purpose of the valves is to allow oil flow from the unfiltered oil zone to the clean oil zone, by-passing the filter media, in cases where the oil filter media 7 is clogged or when viscosity of the oil is too high, ensuring that there will be sufficient lubricating oil within the lubrication system of the engine or machine in which the oil filter is mounted.

As can be seen in the drawings the valve can is adapted to receive a coil spring 6 which is supported by the oil filter housing 8 and force the valve can into contact with the oil filter media with a constant pressure.

In an example of the present invention, the valve can is defined by a spring end 5 and a valve end 12, with a lateral wall having a cylindrical section near the spring end and a conical section tapered toward the valve end. At the spring end, a flange 10 receiving the spring pressure and a skirt 11 clenching the spring are formed.

Item 1, is a basic relief valve design used by some (not all) filter manufacturers. It is always either part of a leaf spring design (non-spring steel) or built in the end disc of the filter media. Item 6 is a coil spring.

The valve end is formed by an external flat surface or valve seat 13 in sealing contact with the valve and an internal “U” shaped surface ending in a tab 14 extended axially from the valve seat, toward an internal side of the valve can which defines the unfiltered oil zone. The valve 1 is constituted by a sealing member 2 and the valve relief spring 3, the valve spring having first and second ends, the first end in contact with the sealing member and the second at the opposite side of the first end. The sealing member is formed by a flat sealing surface and a plurality of elongated members extending axially away from the sealing surface and is mounted on the valve relief spring 3 thorough the inner side the spring and is retained by means of tags extending radially outwardly from the elongated members surrounding the second side of the spring. The first side of the spring is placed within the “U” shaped surface of the valve end of the valve can.

Item 1 is a basic pressure relief valve used in many (but not) all oil filters. Its function is to allow pressure to bypass the filter media in case it is over clogged. This is not unique to this invention. The can 4 is unique to this invention. It has a formed skirt or lip 11 to receive a coil spring 6 and has clinches 16 to keep the spring in place. This unique design can be applied to other types of relief valves besides ones that use 3 and 2.

The coil spring 6 is received by the valve can at the spring end and is placed within the zone defined by the flange 10 and the skirt 11. The skirt 11 having an internal diameter not smaller than the external diameter of the coil spring and having clenches 16 extending radially inwardly from the internal diameter, that allow a fitting assembly between the spring and the valve can, tight enough to keep the spring in place during assembly. The close-fit assembly allows the coil spring/relief valve assembly to be placed as a one piece assembly within the oil filter housing without moving, facilitating the complete assembly of the whole unit.

The new pressure relief valve can design 4 would be made out of tin plate steel (0.010″ thick) in a multi-station progressive. The pressure relief valve assembly 9 would be assembled the same way it is done currently. To assemble item 4 and item 6 would require specialized assembly equipment (IE unique assembly machines used in the industry for making oil filter components.)

The spring/relief valve assembly of the present invention applies constant pressure to the filter media and prevent the relief valve to fall or move out of its preferred position during assembly or rough handling.

Other relief valve designs, could be used in this assembly this “coil spring relief valve assembly”, as long as the designed formed skirt/lip is added and the clinches to hold the spring are used.

This invention is unique to the oil filtration industry. This invention would be placed in the filter media of an oil filter during the assembly process of the filter. It is placed in the end of the filter media that goes towards the bottom of the can. Opposite the tapping plate/threaded plate that screws to the car.

While the invention may be susceptible of various modifications and alternative forms, specific embodiments have been shown by way of example in the drawings and have been described in detail herein. However, it should be understood that the invention is not intended to be limited to the particular forms disclosed. Rather, the invention includes all modifications, equivalents and alternatives falling within the spirit and scope of the invention as defined by the following appended claims.

1. A coil spring/relief valve assembly for oil filters, comprising:
a valve assembly comprising a sealing member and a relief spring;
a coil spring to keep constant pressure against filter media; and
a pressure relief valve can, wherein the pressure relief valve can and the coil spring are clenched together to hold the coil spring in place.

2. A coil spring/relief valve assembly comprising a valve can, a sealing member, a relief spring, a coil spring to keep constant pressure against filter media, and a pressure relief valve can, wherein:
the sealing member and the relief spring are mounted on the pressure relief valve can;
the coil spring and the pressure relief valve can are held together as a one piece assembly.

3. A coil spring/relief valve assembly as claimed in claim 2, wherein the pressure relief valve can and the coil spring are clenched together.

4. An oil filter assembly comprising an oil filter housing, filter media, and a coil spring/relief valve assembly, wherein:
the coil spring/relief valve assembly comprises a valve assembly comprising a valve can, a sealing member, a relief spring, a coil spring to keep constant pressure against the filter media, and a pressure relief valve can;
the sealing member and the relief spring are mounted on the pressure relief valve can;
the coil spring and the pressure relief valve can are held together as a one piece assembly within the oil filter housing; and
the valve can receives the coil spring, which is supported by the oil filter housing, to force the valve can into contact with the oil filter media with a constant pressure.

5. A coil spring/relief valve assembly as claimed in claim 4, wherein the pressure relief valve can and the coil spring are clenched together.
